(19) United States
(12) Patent Application Publication
(10) Pub. No.: US 2009/0213848 A1
(43) Pub. Date: Aug. 27, 2009

(54) Packet Structure and Packet Transmission Method of Network Control Protocol

(75) Inventors: Woong Jeon, Seoul (KR); Jong Hoon Chung, Gyeonggi-do (KR); Sang Kyun Lee, Seoul (KR); Koon Seok Lee, Kyungsang-namdo (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/885,036

(22) PCT Filed: Feb. 23, 2006
(86) PCT No.: PCT/KR06/00629

§ 371 Date: Sep. 9, 2008

(30) Foreign Application Priority Data
Feb. 24, 2005 (KR) 10-2005-0015578

(51) Int. Cl. H04L 12/56; H04J 3/24

(52) U.S. Cl. 370/389; 370/474

(57) ABSTRACT

A packet structure and packet transmission method of a network control protocol. A user in the inside or outside of the house can effectively control various home appliances such as refrigerator or laundry machine or monitor operation state of the devices, over the network such as RS-485 network, low-power RF network, and power line network so that the user can enjoy the remote control and the convenient monitoring. In addition, the packet structure for the inter-layer interface in the network system can be managed. The packet structure at the network layer is generated by assigning one or more fields indicative of a packet start, a destination address, a source address, a packet length, a network layer control, an application layer protocol data unit, a cyclic redundancy check (CRC), and a packet end, and a field indicative of a network layer control. The generated packet structure of the network layer is transmitted to thus interface layers in a network system. Therefore, the packet structure at the network layer can be more efficiently managed and transmitted.

This application is a National Stage entry of PCT Application No. PCT/KR2006/000629, filed Feb. 23, 2006, and claims the benefit of Korean Application No. KR 10-2005-0015578, filed Feb. 24, 2005, each of which are incorporated herein by reference in their entireties.

### BACKGROUND

1. Field of the Disclosure

The present invention relates to a packet structure and a packet transmission method of a network control protocol so that a user, for example, in or out of house, can effectively control household appliances such as refrigerator or laundry machine connected to a network.

2. Discussion of the Related Art

In general, ‘home network’ means a network in which various digital appliances are connected to one another for the user to enjoy economical home services in a convenient and safe way anytime at home or out-of-home, and due to the development of digital signal processing technology, various types of appliances such as refrigerator or laundry machine are being gradually digitalized.

On the other hand, in recent years, home network has been more advanced, since operating system and multi-media technology for appliances has been applied to digital appliances, as well as new types of information appliances have appeared.

Moreover, in a general meaning, a network which is established for providing file exchanges or internet services between personal computers and peripheral devices, a network between appliances for handling audio or video information, and a network established for home automation of various appliances such as refrigerator or laundry machine, appliance control such as remote meter reading, and the like are collectively called a ‘living network’.

Furthermore, in the network services in which small-scale data transmission for the remote control, or operating state monitoring of the appliances included in the network, for example, various appliances such as refrigerator or laundry machine, is the main object of their communication, each of appliances connected to one another should be directly controlled by a network manager, which is included in the network, with the use of the minimum required communication resources. However, its effective solution has not been provided yet, and thus it is a matter of urgency to provide its solution.

### SUMMARY

Accordingly, the present invention is devised in Accordingly, the present invention is devised in consideration of the aforementioned situation, and it is an object of the invention to provide a packet structure and a packet transmission method of a network control protocol so that a user, for example, in or out of house, can effectively control various appliances such as refrigerator or laundry machine connected to a network by using the required communication resources at minimum, and manage and transmit the packet structure at a network layer in the network control protocol far more efficiently for the sake of the interface between network control protocol layers.

In order to achieve the aforementioned object, a packet transmission method of a network control protocol includes generating a packet of the network control protocol at a network layer, the packet assigned one or more fields indicative of a packet start, a destination address, a source address, a packet length, an application layer protocol data unit, a cyclic redundancy check (CRC), and a packet end, and a field indicative of a network layer control; and interfacing layers in a network system by transmitting the generated packet of the network layer.

In accordance with the above aspect of the present invention, a packet structure interfaces layers in a network control protocol including a network layer. The packet structure of the network layer is assigned one or more fields indicative of a packet start, a destination address, a source address, a packet length, an application layer protocol data unit, a CRC, and a packet end, and a field indicative of a network layer control.

In accordance with the above aspect of the present invention, a network device includes a network control protocol including one or more of a physical layer, a data link layer, a network layer, and an application layer, wherein a packet structure of the network layer is assigned one or more fields indicative of a packet start, a destination address, a source address, a packet length, an application layer protocol data unit, a CRC, and a packet end, and a field indicative of a network layer control.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates a construction of a network system according to an embodiment of the present invention;

FIGS. 2 and 3 illustrate a communication configuration based on master-slave applied to the present invention;

FIG. 4 illustrates a layer structure of a living network control protocol (LnCP) applied to the present invention;

FIGS. 5 through 7 illustrate examples of a communication cycle service applied to the present invention;

FIG. 8 illustrates the layer structure of the LnCP protocol according to an embodiment of the present invention;

FIG. 9 illustrates primitives for interfacing between the network management sublayer and the parameter management layer according to an embodiment of the present invention;

FIG. 10 illustrates a layer interface structure according to an embodiment of the present invention;

FIG. 11 illustrates a universal asynchronous receiver and transmitter (URAT) frame structure according to an embodiment of the present invention;

FIG. 12 illustrates primitives for interfacing between the physical layer and the data link layer according to an embodiment of the present invention;

FIG. 13 illustrates primitives for interfacing between the data link layer and the network layer according to an embodiment of the present invention;

FIG. 14 illustrates a data link layer frame structure according to an embodiment of the present invention;

FIG. 15 illustrates a primitive of a master for interfacing between the network layer and the application layer according to an embodiment of the present invention;

FIG. 16 illustrates a primitive of a slave for interfacing between the network layer and the application layer according to an embodiment of the present invention;

FIG. 17 illustrates a packet structure management method at the network layer according to an embodiment of the present invention; and

FIG. 18 illustrates a priority field of the network layer control (NLC) field according to an embodiment of the present invention.

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept, a packet structure at a network layer of a network control protocol and a packet transmission method, by referring to the drawings.

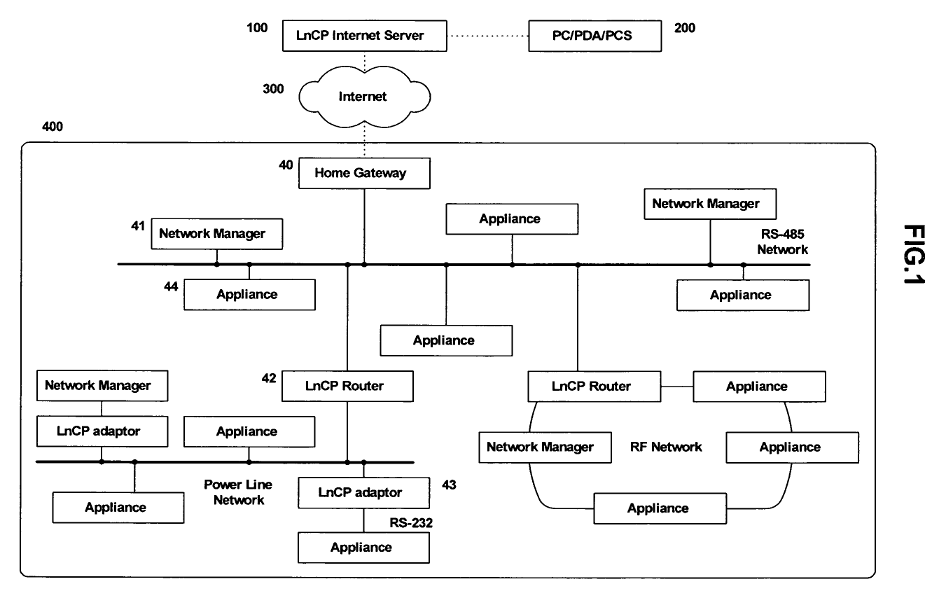

FIG. 1 depicts a construction of a network system according to an embodiment of the present invention. By way of example, a living network control protocol, which is a network control protocol newly defined herein, (LnCP) Internet server 100 and a living network control system 400 that adopt the LnCP newly defined in the present invention, are connected to each other via Internet 300 as shown in FIG. 1. The LnCP Internet server 100 serves to interface with various communication terminals 200 such as a personal computer (PC), a personal digital assistant (PDA), a personal communication service (PCS) and the like.

The living network control system 400 comprises a home gateway 40, a network manager 41, an LnCP router 42, an LnCP adaptor 43, and an appliance 44. The components of the living network control system 400 use a transmission medium having non-standard data link layer such as RS-485 network and low-power RF network, or a transmission medium having standard data link layer such as power line, IEEE 802.411, ZigBee (IEEE 802.15.4), as shown in FIG. 1.

The living network control system 400 can be called ‘LnCP network’. The LnCP network, as shown in FIG. 1, is established by independent networks that connect home appliances belonging to the living network category through a wired or wireless transmission medium in a separate home.

The LnCP network is connected with a master device and a slave device. The master device is responsible to control or monitor operations or operation states of other home appliances. The slave device has a function to reply to a request from the master device and a function to inform information relating to its state change.

The network manager 41 is responsible for the environment setup and the management of the appliance 44 connected to the LnCP network as shown in FIG. 1. The appliance 44 can be connected to the network directly or via the LnCP adaptor 43. A RF-485 network, a RF network, and a power line network within the LnCP network are connected via the LnCP router 42.

The LnCP network provides a function to allow a user at the outside to check or control the state of the appliance in the home over a foreign Internet 300 connected to the LnCP network. To this end, the home gateway 40 functions to connect the LnCP network and the foreign network. After accessing the LnCP Internet server 100 and going through the authentication, the user can check the state of the home appliance connected to the LnCP network or control the home appliance.

Additionally, the user can download contents provided from the LnCP Internet server 100, from the appliance connected to the LnCP network by accessing the LnCP Internet server 100 via the home gateway 40. In this respect, the main features of the LnCP network are described below in detail.

The digital information electronic appliances are equipped with micro-controllers providing diverse capabilities so as to perform their unique functions. According to an embodiment of the present invention, the LnCP network further simplifies the functions with efficiency so that the micro-controller can execute its diverse capabilities. Hence, the resource of the micro-controller equipped to the appliance can be used at minimum. Particularly, a micro-controller having low capability can process the LnCP communication function while executing the unique function of the appliances, and a micro-controller having high capability can support the multi-tasking function.

The main features of the LnCP network can be classified into master-slave based communication configuration, event-driven communication support, support for a plurality of network managers, four-layered structure, communication cycle service, flexible address management, variable-length packet communication, and standard message set provision.

The master-slave based communication configuration is used as a link communication configuration among the home appliances over the LnCP network. At least more than one master device is required, and the master device needs to have information and control codes relating to slave devices to be controlled. The master device controls other slave devices by following a pre-input program or a user's input. Hereafter, the master device is also referred to as a master, and the slave master is also referred to as a slave.

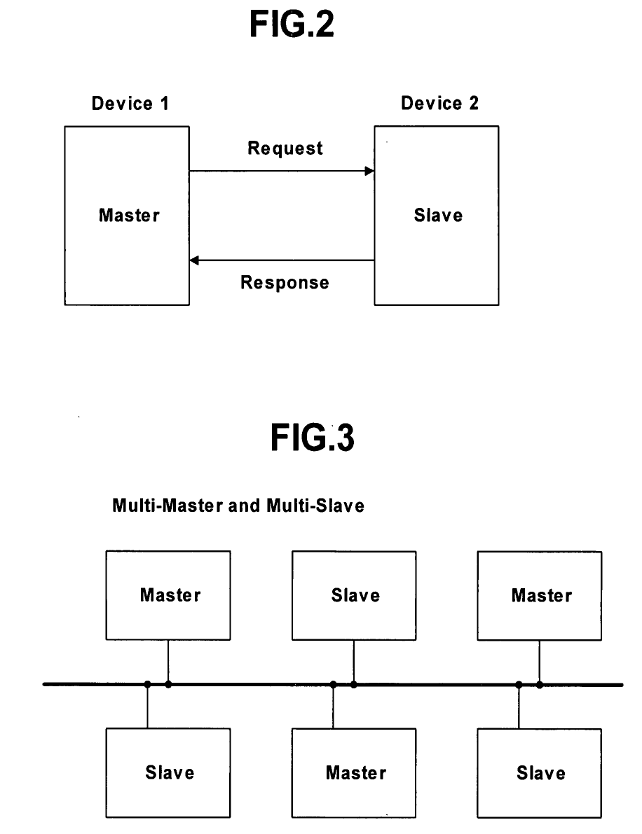

For instance, a message flow between the master and a slave is carried out in a manner that the master sends a request message to the slave and then the slave replies with a response message to the master as shown in FIG. 2. In the LnCP network, a multi-master and multi-slave based communication configuration may be established as shown in FIG. 3.

The LnCP network supports the event-driven communication service. For instance, the user can set a necessary event at the home appliance. When the event set by the user occurs during a certain operation, the home appliance informs other home appliances of the event occurrence or the event contents, or controls the operation state of other home appliances.

At least more than one network manager is included in the LnCP network to take charge of the environment setup and the management of the home appliances. If necessary, the LnCP network can support several network managers. In this case, the management information of the home appliances should be synchronized to avoid errors at the plurality of the network managers in advance.

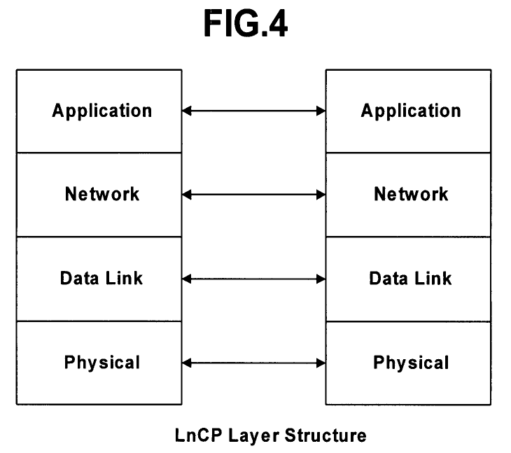

Referring to FIG. 4, the LnCP network has four layers: the physical layer, the data link layer, the network layer, and the application layer. The LnCP network provides services by unit of the communication cycle. In doing so, only one communication cycle is present at a given time point on the slave.

In more detail, although a slave cannot be controlled by any other master during the communication cycle, the master can execute a plurality of communication cycles for a plurality of slave at a given time. Such a communication cycle includes four types: {1-Request, 1-Response}, {1-Request, Multi-Response}, {1-Notification}, and {Repeated-Notification}.

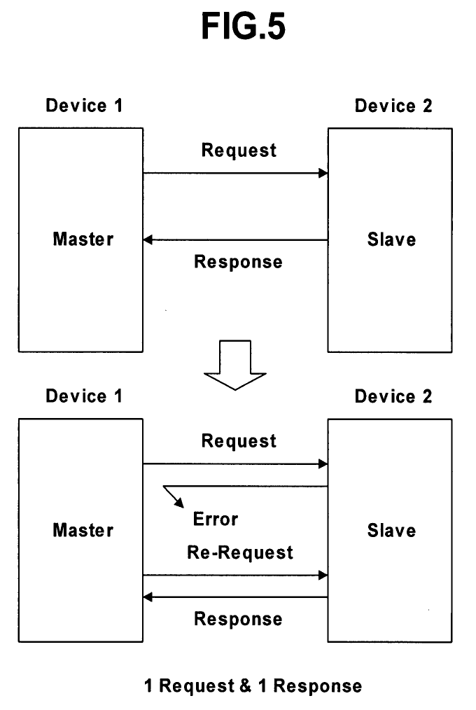

By way of example, during the communication cycle {1-Request, 1-Response}, a master sends a request packet to a slave, and the slave replies with a response packet. If the received packet is erroneous, the master sends a re-request packet and the slave replies a response packet again a shown in FIG. 5.

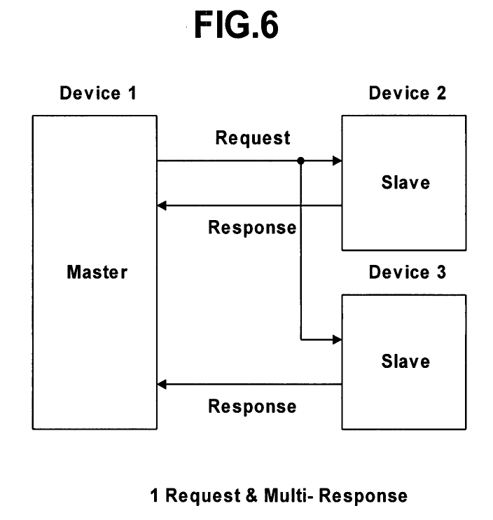

Referring to FIG. 6, during the communication cycle {1-Request, Multi-Response}, a master sends a request packet containing a group address to a plurality of slaves, and each slave sends a response packet in reply to the request packet. The master terminates the cycle after a permissible maximum reception time. When the response packet received after the permissible maximum reception time is erroneous, the master ignores the packet error.

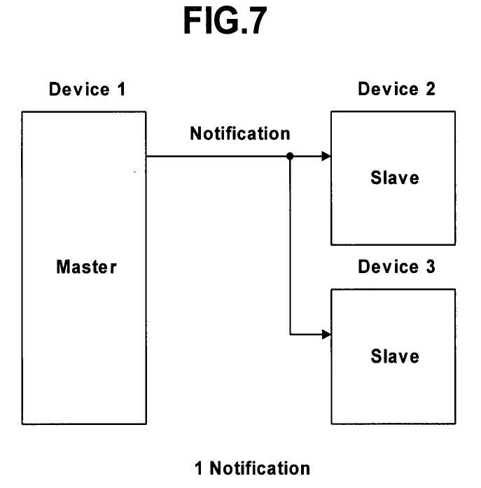

Referring now to FIG. 7, during the communication cycle {1-Notification}, a master terminates the communication immediately after sending a notification packet to one or plural slaves. As for the communication cycle {Repeated-Notification}, the communication is terminated after repeatedly sending the same packet so as to guarantee the transmission reliability in the communication cycle {1-Notification}.

The LnCP network supports the flexible address management. For instance, the home appliances having the LnCP function are assigned addresses according to their types when the home appliances are forwarded from the factory, to thus automatically establish networks. As the home appliances of the same type are initialized to the same address, the network manager is provided with an algorithm to assign unique addresses to the home appliances when they are connected.

Since the LnCP network allocates a unique group address to the home appliance of the same type, the group communication is enabled using merely one message. Also, if necessary, the user can classify a variety of home appliances into clusters and assign group addresses to the clusters, respectively.

The LnCP network supports the variable-length packet communication. For example, in case of downloading contents such as application program relating to the manipulation of the home appliance or uploading data stored in the home appliance, the packet length is adjustable using exchanged buffer size information of the home appliance.

The LnCP network supports the standard message set. For example, a standard message set suitable for various home appliances is defined at the application layer so that the master can control other appliances. The message set is divided into a common function area message set for supporting basic LnCP communication, a product application area message set for supporting the unique function of the home appliance, and a developer area message set for providing unique functions of the manufacturer.

The message set can be expanded if necessary, and argument can be added to a predefined message. In the following, among the main features of the LnCP network, the layer structure is described in further detail.

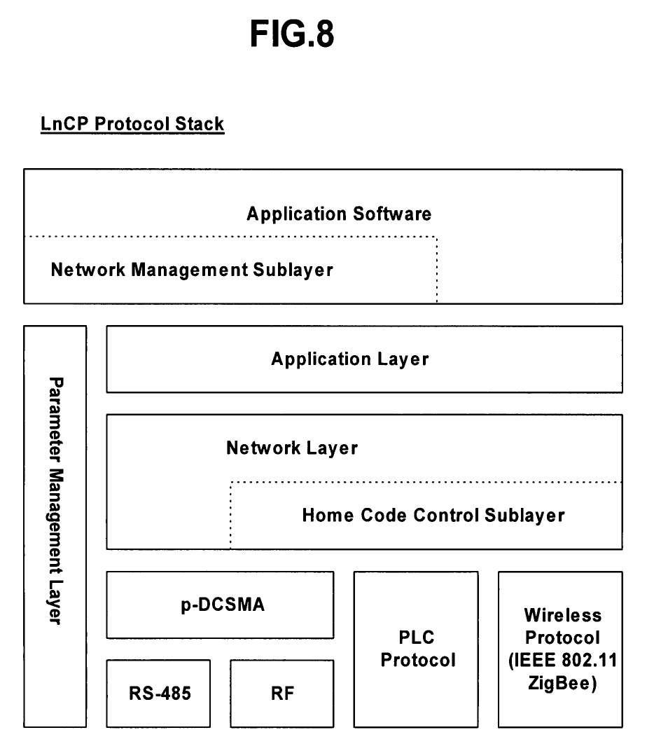

FIG. 8 depicts the layer structure of the LnCP protocol according to an embodiment of the present invention. As discussed above, the LnCP network has the four layers of the physical layer, the data link layer, the network layer, and the application layer for the sake of the operation control and the monitoring of the home appliances such as refrigerator or washer.

The physical layer provides a physical interface between devices, and a function for transmitting and receiving a physical signal such as bits to transmit. The physical layer may employ a transmission medium having the non-standard data link layer such as RS-485 or low-power RF, and a wired or wireless standard transmission medium such as power line communication, Ethernet, IEEE 802.11, and ZigBee. To implement the physical layer of the device at the LnCP network, a separate physical layer may adapt an LnCP adaptor.

The data link layer provides a media access control (MAC) function to use a shared transmission medium. If the data link layer uses a non-standard transmission medium, the LnCP network should conform to a probabilistic-delayed carrier sense multiple access (p-DCSMA) as the MAC protocol.

In contrast, if the data link layer uses a standard transmission medium, the LnCP network can utilize the MAC function specified by a corresponding protocol.

Still referring to FIG. 8, a home code control sublayer provides functions for setting, managing, and processing a home code which is used to logically discriminate the respective networks when the LnCP network is established using the non-standard transmission medium such as power line network, IEEE 802.11, ZigBee, and low-power RF. It is advantageous that the home code control sublayer is not implemented when the respective networks are physically separated by means of the standard transmission medium such as RS-485.

The network layer functions to manage addresses and control the transmission and the reception of the home appliances for the reliable network connections among devices. The application layer serves to control the transmission and the reception and to control the flow for the download and the upload services so as to perform services of application software.

The application layer defines the message set to manage the network or control and monitor the home appliances. The application software executes unique functions of the home appliance and exchanges data with the application layer via an interface designated at the application layer.

As shown in FIG. 8, the network management sublayer functions to manage parameters to set node parameters and to manage the network for the network establishment and the network management. A parameter management layer can set or read parameters used at the respective layers according to a request from the network management sublayer.

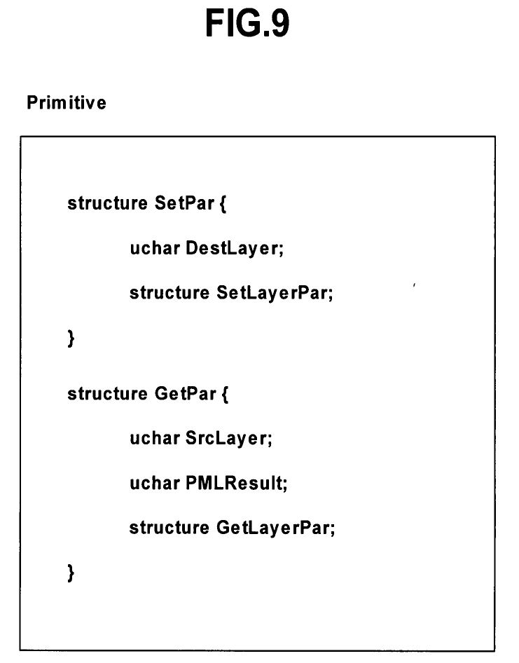

Referring now to FIG. 9, primitives for interfacing with the network management sublayer include a primitive ‘structure SetPar’ for transferring a parameter value from the network management sublayer to the parameter management layer, and a primitive ‘structure GetPar’ to transfer a parameter value from the parameter management layer to the network management sublayer.

The primitive ‘structure SetPar’ for transferring the parameter value to the parameter management layer, includes ‘uchar DestLayer’ indicating a layer the parameter is destined for and ‘structure SetLayerPar’ which is a parameter for each layer and varies according to the value of ‘DestLayer’. The ‘DestLayer’ is 1 when the parameter value is destined for the application layer, 2 when destined for the network layer, 3 when destined for the data link layer, and 4 when destined for the physical layer.

The ‘SetLayerPar’ is ‘SetALPar’ as for the application layer, ‘SetNLPar’ as for the network layer, ‘SetDLLPar’ as for the data link layer, and ‘SetPHYPar’ as for the physical layer.

The primitive ‘structure GetPar’ for transferring the parameter value to the network management sublayer includes ‘uchar SrcLayer’ indicating a layer to which the parameter value is transferred, ‘uchar PMLResult’ indicating whether the parameter value is successively acquired from each layer, and ‘structure GetLayerPar’ which is a parameter for each layer and varies according to ‘SrcLayer’. According to the layer to which the parameter value is transferred, the ‘SrcLayer’ is 1 as for the application layer, 2 as for the network layer, 3 as for the data link layer, and 4 as for the physical layer.

The ‘PMLResult’ is PAR_OK(1) when the parameter value is successively acquired from each layer, and PAR_FAILD(0) when the parameter value is not successively acquired from each layer. The ‘GetLayerPar’ is ‘RptALPar’ as for the application layer, ‘RptNLPar’ as for the network layer, ‘RptDLLPar’ as for the data link layer, and ‘RptPHYPar’ as for the physical layer.

A parameter used at the parameter management layer is ‘const unit ParTimeOut’. The ‘const unit ParTimeOut’ indicates a standby time ms for receiving ‘RptALPar’, ‘RptNLPar’, ‘RptDLLPar’ or ‘RptPHYPar’ after transferring ‘GetALPar’, ‘GetNLPar’, ‘GetDLLPar’ or ‘GetPHYPar’ to each layer.

The parameter management layer, upon receiving the primitive ‘SetPar’ from the network management sublayer, transfers the primitive ‘SetALPar’, ‘SetNLPar’, ‘SetDLLPar’ or ‘SetPHYPar’ to the layer specified in the primitive, and ignores every variable having bit 1, e.g., 0xFF and 0xFFFF, in the primitives received from the respective layers.

Upon receiving the primitive ‘GetPar’ from the network management sublayer, the parameter management layer transfers the primitive ‘GetALPar’, ‘GetLNPar’, ‘GetDLLPar’, or ‘GetPHYPar’ to the layer specified in the primitive. Upon receiving the primitive ‘RptALPar’, ‘RptNLPar’, ‘RptDLLPar’ or ‘RptPHYPar’ from the layer, the parameter management layer transfers the primitive ‘GetPar’ having the value ‘PARResult’ set to PAR_OK to the network management sublayer. In doing so, if the primitive is not received from the layer within the time ‘ParTimeOut’, the primitive is transferred to the network management sublayer by setting the value ‘PARResult’ to ‘PAR_FAILD’.

The network management sublayer provides the parameter management function for setting a node parameter at each device, and the function for establishing the network, setting the environment, and managing the operation of the network.

When a request is received from the application software or the master, the network management sublayer sets or reads out the parameter value of the corresponding layer through the parameter management layer as follows.

For instance, the network management sublayer sets or reads out the parameter value of AddressResult, NP_Alivelnt, SvcTimeout as for the application layer, NP_Logical Address, NP_ClusterCode, NP_HomeCode, SendRetries as for the network layer, MinPktInterval as for the data link layer, and NP_bps as for the physical layer.

Particularly, when receiving a primitive ‘UserPreqRcs’ including the application service belonging to the ‘device node parameter set service’ or the ‘device node parameter acquisition service’ from the application layer, the network management sublayer of the slave sets or reads out the parameter value of the corresponding layer through the parameter management layer, and then transfers the result to the application layer using the primitive ‘UserResSend’. The application service for the parameter management for the layers is as below.

For instance, the application layer has SetOption service, SetAliveTime service, SetClock service, GetBufferSize service, the network layer has SetTemAddress service, SetAddress service, GetAddress service, the data link layer has no service, and the physical layer has SetSpeed service.

The network management sublayer provides the network management functions including the LnCP network establishment, the environment setup, and the network operation management. The general network management functions work above the application layer of the master, and some of network information synchronization functions work above the application layer of the slave during a plurality of network management periods.

The interface with the application layer includes the interface with the application layer of the slave and the interface with the application layer of the master. The interface with the application layer of the slave utilizes primitives ‘UserReqRcv’ and ‘UserResSend’, and the interface with the application layer of the master utilizes primitives ‘UserReq’, ‘UserDLReq’, ‘UserULReq’, ‘UserRes’, ‘UserEventRcv’, and ‘ALCompleted’.

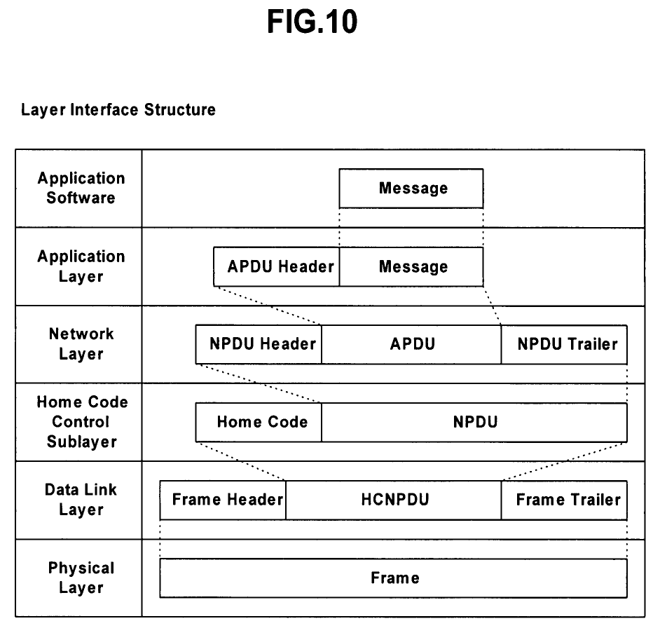

According to an embodiment of the present invention, the inter-layer interfacing method in the living network control system merges header and trailer information required at each layer into a protocol data unit (PDU) received from an upper layer, and transfers it to a lower layer as shown in FIG. 10.

By way of example, an application layer PDU (APDU) is delivered between the application layer and the network layer, and consists of an APDU header and a message. A network layer PDU (NPDU) is delivered between the network layer and the data link layer or the home code control sublayer, and consists of a NPDU header, a NPDU trailer, and the APDU. The NPDU header may be addresses of the APDU and the NPDU, an address of a destination home appliance, and a packet type according to the significance of the transferred message.

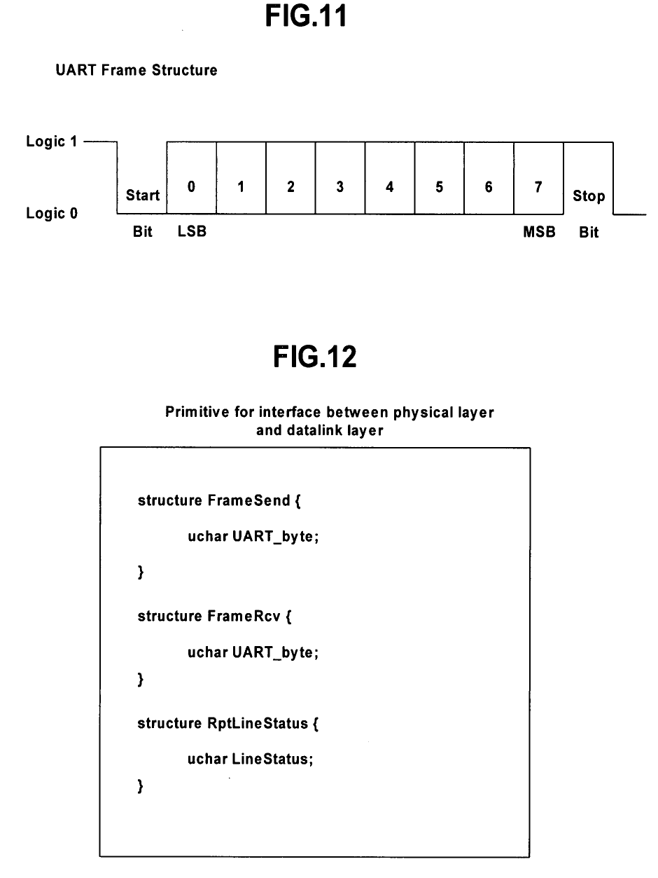

A home code control sublayer PDU (HCNPDU) is delivered between the network layer and the data link layer, and consists of the NPDU and a home code. The physical layer of the LnCP network takes advantage of a universal asynchronous receiver and transmitter (UART) frame structure, as shown in FIG. 11, for the interface between the device and the LnCP adaptor or the LnCP router.

A packet received from the upper layer is converted to a UART frame unit of 10-bit size and transferred through the transmission medium. The UART frame of the LnCP network consists of a 1-bit start bit, 8-bit data, and a 1-bit stop bit. The UART frame does not use a parity bit, and the bits from the start bit to the stop bit are transferred in that order.

In case that the UART is adopted in the LnCP network, additional frame headers and frame trailers are not used. At this time, the data speed may be 9600 bps, 4800 bps, or 19200 bps depending on the device capability.

Referring to FIG. 12, primitives for the interface between the physical layer and the data link layer are a primitive ‘FrameSend’ for transferring 1-byte data from the data link layer to the physical layer, a primitive ‘FrameRcv’ for transferring 1-byte data from the physical layer to the data link layer, and a primitive ‘RptLineStatus’ relating to the link status linked to the data link layer. When the UART frame is present in the line, LINE_BSY is transferred, or otherwise, LINE-IDLE is transferred.

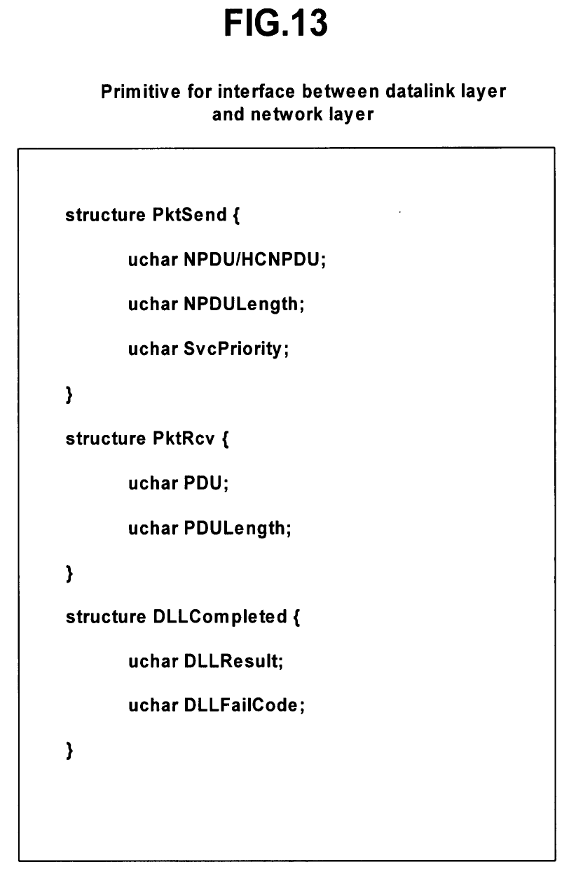

As shown in FIG. 13, primitives for the interface between the data link layer and the network layer are a primitive ‘PktSend’ for transferring packets from the network layer to the data link layer, a primitive ‘PktRcv’ for transferring packets from the data link layer to the network layer, and a primitive ‘DLLComplete’ for informing of the packet transfer result from the data link layer to the network layer.

The primitive ‘PktSend’ contains records of the packet NPDU/HCNPDU of the network layer, the byte data length of the NPDU/HCNPDU, and the transfer priority ‘SvcPriority’. The primitive ‘PktRcv’ contains records relating to the packet PDU of the network layer and the data length of PDU ‘PDULength’. When the packet transfer is successfully completed as the packet transfer result ‘DLLResult’, ‘SEND_OK(1)’ is recorded in the primitive ‘DLLCompleted’, or otherwise, ‘SEND_FAILED(0)’ is recorded. When the ‘DLLResult’ is ‘SEND_FAILD(0)’, a value classifying the failure cause ‘DLLFailCode’ is recorded.

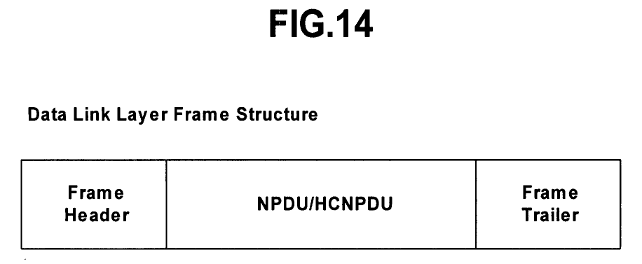

Referring to FIG. 14, the data link frame structure consists of a frame header and a frame trailer in addition to the NPDU/HCNPDU. If the data link layer uses the non-standard transmission medium, a null field is recorded in the frame header and the frame trailer. If the standard transmission medium is used, the corresponding protocol is conformed. The NPDU field is a data unit transferred from the upper network layer.

The HCNPDU is a data unit to which the home code, which is used in case that the physical layer is the non-standard transmission medium, is appended to the front. The data link layer does not discriminate between the NPDU and the HCNPDU during the processing.

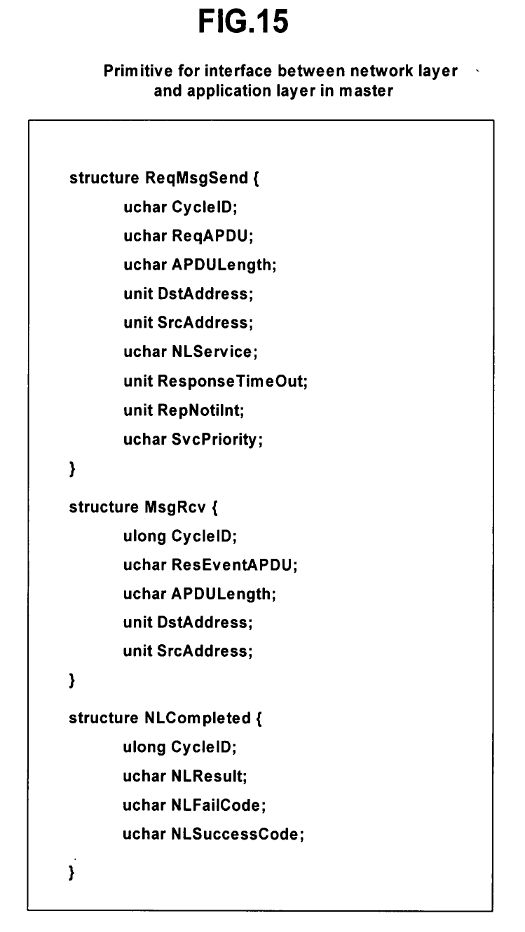

The interface of the network layer differs depending on the master and the slave. Referring to FIG. 15, for the interface between the network layer and the application layer, the master utilizes the primitives ‘ReqMsgSend’, ‘MsgRcv’, and ‘NLCompleted’. The primitive ‘ReqMsgSend’ for transferring a message from the application layer to the network layer at the master, includes records relating to an identification (ID) of the communication cycle ‘CycleID’, an ADPU including the request message originated at the application layer of the master ‘ReqADPU’, a byte data length of the ADPU ‘APDULength’, an address of the destination device ‘DstAddress’, an address of the source device ‘SrcAddress’, a communication cycle service type of the master ‘NLService’ (e.g., 0=Acknowledged, 1=Non-acknowledged, 2=Repeated-notification), a time ‘ResponseTimeOut’ for expecting a response packet after transferring the request packet to the master when the “NLService” is ‘Acknowledged’, a time interval ‘RepNotiInt’ between the consecutive notification packets when the ‘NLService’ is ‘Repeated-notification’, and a transmission priority of the request message ‘SvcPriority’.

The primitive ‘MsgRcv’ for delivering packets from the network layer to the application layer of the master, contains records relating to the ID of the communication cycle ‘CycleID’, the APDU to be transferred to the application layer ‘ResEventAPDU’, the byte data length of the APDU ‘APDULength’, the address of the destination device ‘DstAddress’, and the address of the source device ‘SrcAddress’.

The primitive ‘NLCompleted’ for informing the packet process state from the network layer to the application layer, contains the ID of the communication cycle “CycleID” and the result of the communication cycle ‘NLResult’. In case of the successful communication cycle, ‘CYCLE_OK(1)’ is recorded, or otherwise, ‘CYCLE_FAILED(0)’ is recorded. When the ‘NLService’ is ‘CYCLE_FAILED’, a value classifying the failure cause ‘NLFailCode’ is recorded. When the ‘NLService’ is ‘CYCLE_OK”, the number of the re-transmission times ‘NLSuccessCode’ is recorded.

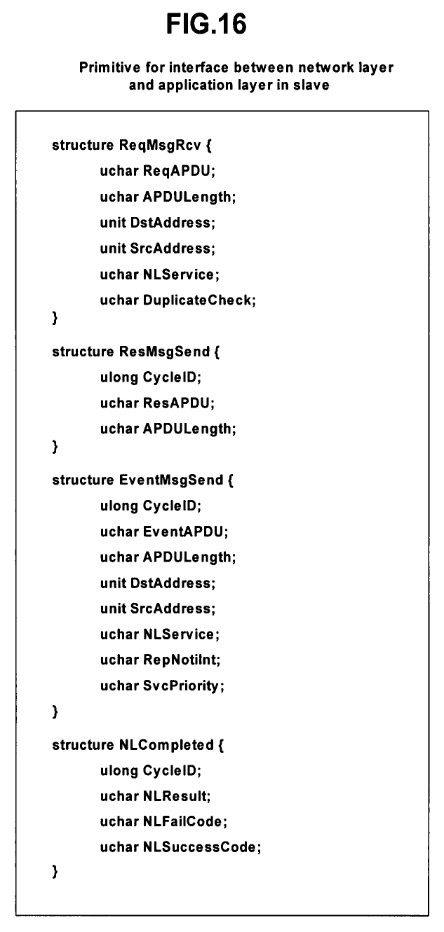

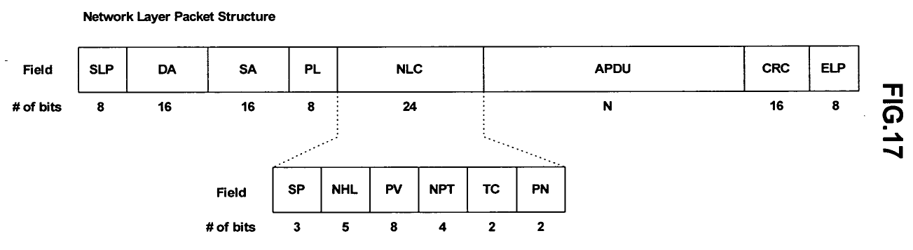

Referring to FIG. 16, the slave utilizes primitives ‘ReqMsgRcv’, ‘ResMsgSend’, ‘EventMsgSend’, ‘NLCompleted’ for the interface between the network layer and the application layer. The primitive ‘ReqMsgRcv’ for forwarding the request message transferred from the network layer to the application layer contains the APDU to be transferred to the application layer ‘ReqAPDU’, the byte data length of the APDU ‘APDULength’, the address of the destination device ‘DstAddress’, the address of the source device ‘SrcAddress’, and the communication cycle service type of the slave ‘NLService’ (e.g., 0=Acknowledged, 1=Non-acknowledged). In addition, when a result of the duplicate packet detection is normal, ‘NORMAL_PKT(1) is recorded. When a duplicate packet is detected, ‘DUPLICATED_PKT(0)’ is recorded.

The primitive ‘ResMsgSend’ for delivering a response message from the application layer to the network layer of the slave, contains the ID of the communication cycle ‘CycleID”, the APDU including a response message ‘ResAPDU’ originated by the application layer of the slave, and the byte data length of the APDU ‘APDULength’.

The primitive ‘EventMsgSend’ for transferring a message from the application layer to the network layer of the slave, contains the ID of the communication cycle ‘CycleID’, the APDU including an event message ‘EventAPDU’ originated by the application layer of the slave, the byte data length of the APDU ‘APDULength’, the address of the destination device ‘DstAddress’, the address of the source device ‘SrcAddress’, and the transmission service at the network layer ‘NLService’ (e.g., 1=Non-acknowledged, 2=Repeated-notification). When the ‘NLService’ is ‘Repeated-notification’, the time interval between consecutive notification packets ‘RepNotiInt’ and the transmission priority of the event message ‘SvcPriority’ are recorded.

The primitive ‘NLCompleted’ for informing the packet process state from the network layer to the application layer, contains the ID of the communication cycle ‘CycleID” and the result of the communication cycle ‘NLResult’. In case of the successful communication cycle, ‘CYCLE_OK(1)’ is recorded, or otherwise, ‘CYCLE_FAILED(0)’ is recorded. When the ‘NLService’ is ‘CYCLE_FAILED’, a value classifying the failure cause ‘NLFailCode’ is recorded. When the ‘NLService’ is ‘CYCLE_OK”, the number of the re-transmission times ‘NLSuccessCode’ is recorded.

FIG. 17 depicts the packet structure management method at the network layer according to an embodiment of the present invention. The packet structure at the network layer comprises a start of LnCP packet (SLP) field, a destination address (DA) field, a source address (SA) field, a packet length (PL) field, a network layer control (NLC) field, an APDU field, a cyclic redundancy check (CRC) field, and an end of LnCP packet (ELP) field.

The SLP field has a value of 0x02 in 8-bit length indicative of the start of the packet. The DA field and the SA field are node addresses of the receiver and the transmitter of the packet, respectively, and each consist of 16 bits. The most significant bit is assigned as a flag indicative of the group address, the subsequent seven bits indicate the type of the home appliance, and the other eight bits are assigned to discriminate a plurality of the home appliances of the same kind.

The PL field indicates the total length of the NPDU to transfer. The PL field consists of 16 bytes at minimum and 255 bytes at maximum. The NLC field consists of 24 bits. The APDU field is the protocol data unit of the application layer which is transferred between the application layer and the network layer. The APDU is 0 byte at minimum and 88 bytes at maximum.

The CRC field consists of 16 bits for detecting error of the received packet, for example, error between the SLP field to the APDU field. In the embodiment of the present invention, the LnCP adopts the CCITT-16 CRC calculation algorithm. The ELP field indicates the end of the packet and has a value of 0x03. In case that ELP field is not detected even though the data is received corresponding to the length recorded in the LP field, the packet error is determined.

Still referring to FIG. 17, the NLC field comprises a service priority (SP) field, a NPDU header length (NHL) field, a protocol version (PV) field, a network layer packet type (NPT) field, a transmission counter (TC) field, and a packet number (PN) field.

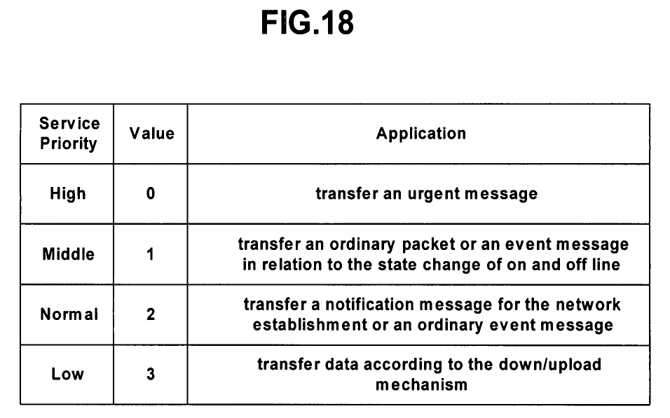

The SP field is a 3-bit field for assigning priority to the transferred messages. Referring to FIG. 18, the SP of the transferred messages is high, the application has a value of ‘0’ and used to transfer an urgent message. When the priority is middle, the application has a value of 1 and used to transfer an ordinary packet or an event message in relation to the state change of on and off line.

When the priority is normal, the application has a value of ‘2’ and used to transfer a notification message for the network establishment or an ordinary event message. When the priority is low, the application has a value of ‘3’ and used to transfer data according to the down/upload mechanism. When the slave replies to the request of the master, the priority of the response message is determined according to the priority of the request message received from the master.

The NHL field indicates the length of the NPDU header, that is, the length from the SLP field to the NLC field. The NHL field consists of 9 bytes without extension and may be extended up to 16 bytes at maximum. The PV field indicates the protocol version. In the PV field, four upper bits are allocated to a version field and four lower bits are allocated to a sub-version field. The version and the sub-version represent the version in hexadecimal numbers.

For example, a version 1.0 has a field value of 0x10, a version 1.1 has 0x11, a version 1.15 has 0x1F, and a version 2.0 has 0x20. The network layer of the version 2.0 should be capable of processing the NPDU of the other lower versions.

The NPT field is a 4-bit field for discriminating the packet type at the network layer. In the embodiment of the present invention, the LnCP utilizes the request packet, the response packet, and the notification packet, by way of example. The NPT field value 0 indicates the request packet, the NPT field value 1˜3 indicates non-use, the NPT field value 4 indicates the response packet, the NPT field value 5˜7 indicates non-use, and the NPT field value 8 indicates the notification value.

In addition, the NPT field value 9˜12 indicates the non-use, and the NPT field values 13˜15 can be reserved for the interface with the home code control sublayer. The NPL field of the master should be set to the request packet or the notification packet, and the NPL field of the slave should be set to the response packet or the notification packet.

The TC field is a 2-bit field to retransfer the request packet in case that the request packet or the response packet is not successfully transferred because of communication error occurring at the network layer, or to repeatedly transfer the notification packet so as to improve the data rate of the notification packet. The destination can detect the duplicate message using the TC field value. The master can retransfer the request packet as many times as the number specified in ‘SendRetries’ when the response packet is not received within ‘ResponseTimeOut’. The slave can retransfer the notification packet originated at the application layer as many times as the number specified in ‘SendRetries’.

The TC field value is set to 1 at the initial transmission, and increases by one when the retransmission is requested or the repeat transmission is required. The range of the TC field according to the NPT value is set to 1˜3 as for the request packet, 1 as for the response packet, and 1˜3 as for the notification packet, by way of example.

The PN field consists of two bits. By uses the PN field, the slave detects the duplicate packet together with the TC field, and the master processes a plurality of communication cycles. When transferring a new packet, the PN field value increases by one at the master.

When the same packet is retransferred, the previous PN field value is retained. When the resultant value of the increment is 4, the PN field value is set to 0. When transferring the response packet, the slave duplicates the PN field value of the received request packet. When the slave transmits the notification packet, the PN field value is set to 0 if the result of the increment by one is 4. The range of the PN field according to the NPT value is set to 0˜3 as for the request packet, the duplicate PN value of the request packet as for the response packet, and 0˜3 as for the notification packet.

In view of the foregoing, the packet structure as constructed above, and the packet transmission method of the network control protocol can provide the user with the remote control and the convenience monitoring. Furthermore, the packet structure at the network layer can be more efficiently set and managed.

As describe above, while the present invention has been disclosed for the purpose of illustration with reference to the aforementioned preferred embodiment, other various names can be given to the living network and more various appliances can be connected to a living network according to the present invention, and it will be understood by those skilled in the art that the foregoing embodiment can be improved, modified, substituted or added in a variety of ways without departing from the technical spirit and scope of the invention as defined by the appended claims.

1. A packet transmission method of a network control protocol comprising:
generating a packet of the network control protocol at a network layer, the pack et assigned one or more fields indicative of a packet start, a destination address, a source address, a packet length, an application layer protocol data unit, a cyclic redundancy check (CRC), and a packet end, and a field indicative of a network layer control; and
interfacing layers in a network system by transmitting the generated packet of the network layer.

2. The packet transmission method according to claim 1, the packet start field consists of 8 bits and has a value of 0x02.

3. The packet transmission method according to claim 1, wherein the destination address field and the source address field indicate a node address of the destination and the source of the packet to transmit, respectively, and each consist of 16 bits, and
the most significant bit is assigned as a group address, subsequent seven bits are assigned as a type of a home appliance, and other lower eight bits are assigned to discriminate a plurality of home appliances of the same kind.

4. The packet transmission method according to claim 1, wherein the packet length field indicates a total length of a network layer protocol data unit, and consist of 16 bytes at minimum to 255 bytes at maximum.

5. The packet transmission method according to claim 1, wherein the network layer control field is assigned one or more fields indicative of a priority, a header length, a protocol version, a packet type, a number of transmission times, and a packet number.

6. The packet transmission method according to claim 5, wherein the priority field consists of 3 bits for assigning priority to transmission messages, and
the priority field has a value of 0 when the priority is high, the priority field has a value of 1 when the priority is middle, the priority field has a value of 2 when the priority is normal, and the priority field has a value of 3 when the priority is low.

7. The packet transmission method according to claim 6, wherein priority of a response message is determined according to priority of a request message received from a master when a slave replies to the request of the master.

8. The packet transmission method according to claim 5, wherein the header length field indicates a length from the packet start field to the network layer control field.

9. The packet transmission method according to claim 5, wherein the protocol version field indicates a version of an adapted protocol, and
four upper bits indicate a main version and four lower bits indicate a subversion.

10. The packet transmission method according to claim 5, wherein the packet type field is a 4-bit field for discriminating a type of the packet at the network layer, and indicate at least one of a request packet, a response packet, and a notification packet.

11. The packet transmission method according to claim 10, wherein the packet type field is set to the request packet or the notification packet as for the master, and the packet type field is set to the response packet or the notification packet as for the slave.

12. The packet transmission method according to claim 5, wherein the number of transmission times field is a 2-bit field to retransmit a request packet when the network layer does not successfully transfer a request packet or a response packet, or to repeatedly transfer a notification packet for improving a data rate of the notification packet.

13. The packet transmission method according to claim 5, wherein the packet number field consists of 2 bits, is used for the slave to detect whether a received packet is duplicated together with the number of transmission times field, is used for the master to process a plurality of communication cycles, and increases by one for every transmission of a new packet.

14. The packet transmission method according to claim 1, wherein the CRC field consists of 16 bits to detect error between the packet start field and the application layer protocol data unit field.

15. The packet transmission method according to claim 1, wherein the packet end field indicates the end of the packet and has a value of 0x03, and
a packet error is determined when the packet end field is not detected even though data corresponding to a length recorded in the packet length field is received.

16. The packet transmission method according to claim 1, wherein the network control protocol includes one or more of a physical layer, a data link layer, a network layer, and an application layer.

17. The packet transmission method according to claim 1, wherein the generated packet of the network layer is transmitted to other layer of the network control protocol.

18. A packet structure for interfacing layers in a network control protocol including a network layer, wherein the packet structure of the network layer is assigned one or more fields indicative of a packet start, a destination address, a source address, a packet length, an application layer protocol data unit, a CRC, and a packet end, and a field indicative of a network layer control.

19. The packet structure according to claim 18, wherein the network layer control field is assigned one or more fields indicative of a priority, a header length, a protocol version, a packet type, a number of transmission times, and a packet number.

20. A network device which includes a network control protocol including one or more of a physical layer, a data link layer, a network layer, and an application layer, wherein a packet structure of the network layer is assigned one or more fields indicative of a packet start, a destination address, a source address, a packet length, an application layer protocol data unit, a CRC, and a packet end, and a field indicative of a network layer control.
